(19) United States
(12) Patent Application Publication
(10) Pub. No.: US 2006/0122828 A1
(43) Pub. Date: Jun. 8, 2006

(54) Highband speech coding apparatus and method for wideband speech coding system

(76) Inventors: Mi-Suk Lee, Daejon (KR); Jong-Mo Sung, Daejon (KR); Do-Young Kim, Daejon (KR); Hyun-Woo Kim, Seoul (KR); Kyung-Tae Kim, Seoul (KR); Hong-Goo Kang, Gyeonggi-dol (KR); Dae-Hee Youn, Seoul (KR); Sung-Kyo Jung, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/243,955

(22) Filed: Oct. 4, 2005

(30) Foreign Application Priority Data
Dec. 8, 2004 (KR) 10-2004-0103158

(51) Int. Cl. G10L 19/10

(52) U.S. Cl. 704/219

(57) ABSTRACT

Provided is a highband coding apparatus and method for a wideband coding system. The coding apparatus and method can reduce a pre-echo phenomenon by encoding the highband based on lowband encoding information and Temporal Noise Shaping technique. A highband encoding apparatus includes: a domain converter for converting the domain of an input highband signal into a frequency domain; a linear prediction order determiner for determining a linear prediction order based on the lowband encoding information; a linear prediction analyzer for analyzing a highband signal of the frequency domain based on the determined linear prediction order to thereby generate a linear prediction coefficient; a linear prediction coefficient quantizer for quantizing the linear prediction coefficient based on the lowband encoding information; and a residual signal quantizer for obtaining a residual signal by dequantizing the quantized linear prediction coefficient and quantizing the residual signal.

### FIELD OF THE INVENTION

The present invention relates to wideband signal encoding and decoding systems; and, more particularly, to a highband encoding apparatus and method for encoding highband signal (speech or audio) by using the encoding informaion of lowband encoder in a wideband signal encoding system which uses the conventional narrowband encoder as a core encoder and a highband decoding apparatus and method corresponding thereto.

### DESCRIPTION OF RELATED ART

Generally, wideband signal (speech or audio) encoding methods are largely categorized into three types. One is a wideband encoding method for encoding wideband signals ranging from 50 to 7,000 Hz at a time. Second is a band-splitting encoding method which encodes the lowband and highband signal with independent methods after dividing wideband signals into lowband signals ranging from 50 to 4,000 Hz and highband signals ranging from 4,000 to 7,000 Hz. Third algorithm is a step-based encoding method. In this method, first, lowpass filtered and down-sampled input signal is encoded by narrowband encoder and then the difference between wideband input signal and up-sampled lowband signal is encoded. Since the difference between the wideband input signal and the up-sampled lowband signal is mostly concentrated on the highband region, the encoding of highband signal is significant in quality improvement.

The band-splitting or the step-based wideband signal encoding system usually utilizes a standardized narrowband encoder for lowband signal encoding and utilizes a noise modulation and a frequency domain encoding technique for highband signal encoding. Herein, the bandwidth of narrowband (the telephone band) is between 0 and 4 kHz and the typical narrowband encoder are ITU-T, G.723.1, G.729.1, EVRC and the like. Thus, the band-splitting or step-based wideband signal encoding system is compatible with a narrowband encoder, which is applied to conventional communication systems.

Meanwhile, the noise modulation technique used for the encoding of highband signal in the conventional wideband signal encoding system performs modeling the highband signal by modulating random noise signals based on the energy distribution of highband signal. The noise modulation technique is very low-complexity method but just conveys the feeling of wideband signal. Also, it is not appropriate for the encoding of various types of signal.

In the frequency domain encoding technique, the input signal is transformed by using a transform algorithm such as Discrete Fourier Transform (DFT) and Discrete Cosine Transform (DCT), and the frequency coefficients are quantized and transmitted. In the frequency domain encoding technique, the waveform of a input signal is directly encoded. Thus the frequency domain encoding technique is appropriate for encoding various input signals. However, the frequency domain encoding technique has pre-echo problem because the onset pulses is frequently occur in the highband. If the onset segment is encoded in frequency domain, the quantization noises are spreaded over the entire frequency band. In other words, the quantization error occurring in a pitch pulse segment or an onset pulse segment due to a limited transmission rate causes a pre-echo synthesized signal.

### SUMMARY OF THE INVENTION

It is, therefore, an object of the present invention to provide a highband encoding apparatus and method that can reduce a pre-echo phenomenon by using Temporal Noise Shaping (TNS) technique and encoding information of lowband signal in a wideband encoding system.

It is another object of the present invention to provide a highband decoding apparatus and method for decoding highband signals which are encoded by using the highband encoding apparatus and method in a wideband decoding system.

The objects and other advantages can be understood with reference to the following description and become apparent by preferred embodiments of the present invention. Also, it is obvious that the objects and advantages can be embodied by the means as claimed and combinations thereof.

In accordance with an aspect of the present invention, there is provided a highband encoding apparatus for encoding a highband signal based on lowband encoding information in a wideband encoding system, including: a domain converter for converting a domain of an input highband signal into a frequency domain; a linear prediction order determiner for determining a linear prediction order based on the lowband encoding information; a linear prediction analyzer for analyzing a highband signal whose domain is converted into the frequency domain based on the determined linear prediction order to thereby generate a linear prediction coefficient; a linear prediction coefficient quantizer for quantizing the linear prediction coefficient based on the lowband encoding information; and a residual signal quantizer for obtaining a residual signal by dequantizing the quantized linear prediction coefficient and quantizing the residual signal.

In accordance with another aspect of the present invention, there is provided a highband decoding apparatus for decoding a highband signal based on lowband encoding information in a wideband decoding system, including: a residual signal decoder for decoding a residual signal from a received bit stream; a linear prediction order determiner for determining a linear prediction order based on the lowband encoding information; a linear prediction coefficient dequantizer for dequantizing a linear prediction coefficient from the received linear prediction coefficient information by using the determined linear prediction order and the lowband encoding information; a linear prediction synthesizer for performing linear prediction synthesis on the decoded residual signal by using the dequantized linear prediction coefficient; and a domain converter for converting a highband signal performed linear prediction synthesis into a highband signal of a time domain.

In accordance with another aspect of the present invention, there is provided a highband encoding method for encoding a highband signal based on lowband encoding information in a wideband encoding system, including the steps of: a) converting a domain of an input highband signal into a frequency domain; b) determining a linear prediction order based on the lowband encoding information; c) analyzing the highband signal whose domain is converted into the frequency domain based on the determined linear prediction order and generating a highband linear prediction coefficient; d) quantizing the linear prediction coefficient based on the lowband encoding information; and e) obtaining a residual signal by dequantizing the quantized linear prediction coefficient, and quantizing the obtained residual signal.

In accordance with another aspect of the present invention, there is provided a highband decoding method for decoding a highband signal based on lowband encoding information in a wideband decoding system, including the steps of: a) decoding a residual signal from a received bit stream; b) determining a linear prediction order based on the lowband encoding information; c) dequantizing a linear prediction coefficient from the received linear prediction coefficient information based on the determined linear prediction order and the lowband encoding information; d) performing linear prediction synthesis on the decoded residual signal based on the dequantized linear prediction coefficient; and e) converting a highband signal performed linear prediction synthesis into a highband signal of a time domain.

### BRIEF DESCRIPTION OF THE DRAWINGS

The above and other objects and features of the present invention will become apparent from the following description of the preferred embodiments given in conjunction with the accompanying drawings, in which:

FIG. 1 is an exemplary block diagram showing band-splitting wideband signal encoding and decoding systems to which the present invention is applied;

FIG. 2 is a block diagram describing a highband encoding apparatus in accordance with an embodiment of the present invention;

FIG. 3 is a diagram illustrating a linear prediction coefficient (LPC) quantizer of FIG. 2;

FIG. 4 is a block diagram showing a highband decoding apparatus in accordance with an embodiment of the present invention;

FIG. 5 is a block diagram illustrating a linear prediction coefficient dequantizer of FIG. 4;

FIG. 6 is a flowchart describing a highband encoding method in accordance with an embodiment of the present invention;

FIG. 7 is a flowchart illustrating a linear prediction coefficient quantizing process of FIG. 6;

FIG. 8 is a flowchart showing a highband decoding method in accordance with an embodiment of the present invention; and

FIG. 9 is a flowchart illustrating a linear prediction coefficient dequantizing process of FIG. 8.

### DETAILED DESCRIPTION OF THE INVENTION

Other objects and aspects of the invention will become apparent from the following description of the embodiments with reference to the accompanying drawings, which is set forth hereinafter. When it is determined that further description on a prior art related to the technology of the present may blur the points of the present invention, the description will not be provided. Hereinafter, preferred embodiments of the present invention will be described in detail with reference to the accompanying drawings.

In the Temporal Noise Shaping (TNS) technology, the LPC residual coefficients of frequency domain are quantized and transmitted. The input signal are transformed int to frequency domain based on Discrete Fourier Transform (DFT) or Discrete Cosine Transform (DCT) and linear prediction coefficients are calculated on the transformed signals. The present invention provides a solution on the determination of an optimal order and quantization method of linear prediction coefficient (LPC).

When the exact frequency band split is impossible, lowband encoding information can be used for highband linear prediction analysis because highband signals include some part of lowband signals and the energy distribution of a highband signal on a time axis is similar to the energy distribution of a lowband signal.

For example, it is possible to use the pitch information of lowband encoder to determine a linear prediction order and to use a lowband synthesised signal to quantize a linear prediction coefficient in the encoding of highband signal.

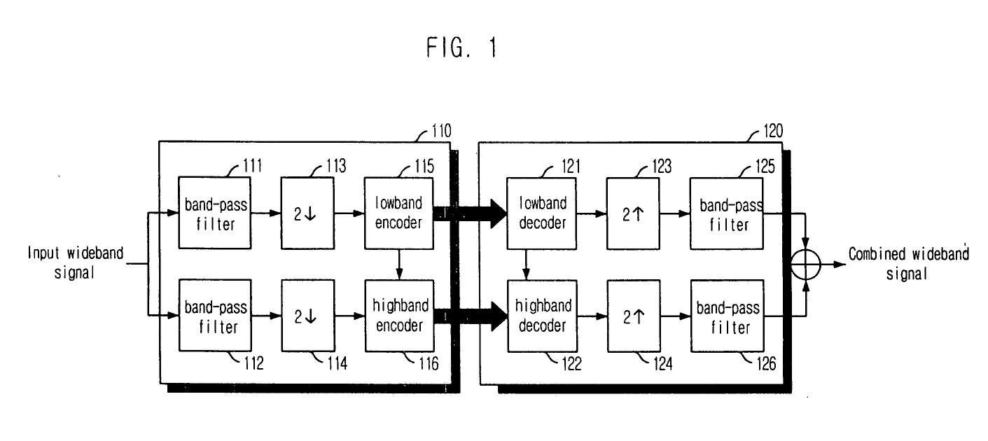

FIG. 1 is an exemplary block diagram showing band-splitting wideband encoding and decoding systems to which the present invention is applied.

As shown in FIG. 1, a band-splitting wideband encoding system 110 divides an input wideband signal into a lowband signal and a highband signal in a band-pass filter of lowband 111 and a band-pass filter of highband 112. The lowband signal and highband signal are decimated by a half in decimators 113 and 114 and inputted into lowband and highband encoders 115 and 116, respectively.

Meanwhile, a band-splitting wideband decoding system 120 decodes the received encoded parameters of lowband and highband, and interpolates the decoded lowband and highband signals by using interpolators 123 and 124 in two-folds. The interpolated lowband and highband signals pass through a band-pass filter of lowband 125 and a band-pass filter of highband 126, respectively, and they are synthesized to wideband signal.

The encoding apparatus and method of the present invention can be applied to a highband encoder 116 of the wideband encoding system 110, whereas the decoding apparatus and method of the present invention can be applied to a highband decoder 122 of the wideband encoding system 120. However, it is obvious to those skilled in the art that the scope of the present invention is not limited to it.

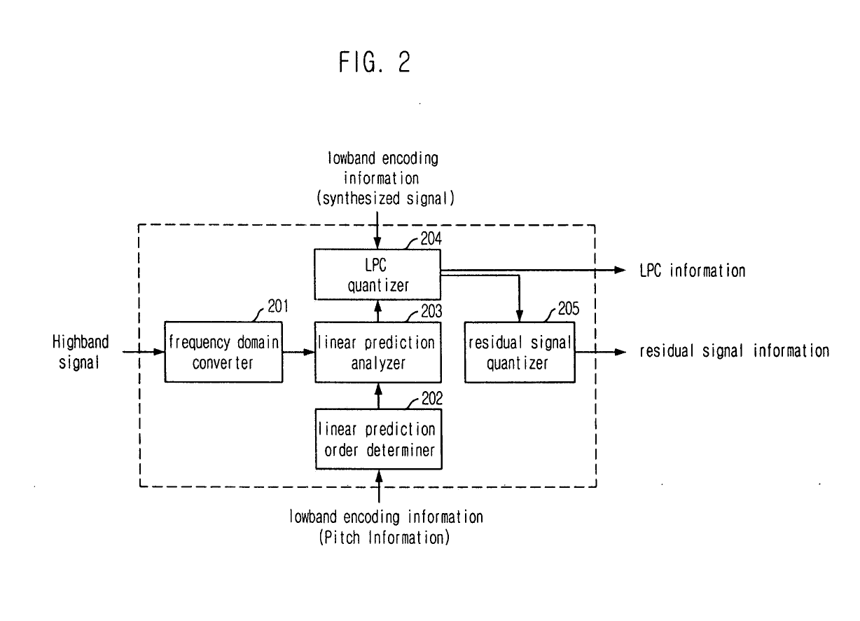

FIG. 2 is a block diagram describing a highband encoding apparatus in accordance with an embodiment of the present invention. As shown, the highband encoding apparatus includes a frequency domain converter 201, a linear prediction order determiner 202, a linear prediction analyzer 203, a linear prediction coefficient quantizer 204, and a residual signal quantizer 205.

The frequency domain converter 201 transform the time domain of a highband signal into a frequency domain. In the present embodiment, the highband signal is converted into a frequency domain through Modified Discrete Cosine Transform (MDCT) and generates an MDCT coefficient through the frequency domain transform.

The linear prediction order determiner 202 determines a linear prediction order based on lowband encoding information such as pitch. The linear prediction order (p) can be expressed as Equation 1.

$$p = 2 ⨯ [ \frac{{N}_{W}}{T} ] \qquad Eq . 1$$

where N_{W} denotes a frame length of a wideband encoding system; T denotes a pitch value obtained in lowband encoding system; and

$$[ \frac{{N}_{W}}{T} ]$$

denotes the number of pitch pulses per one frame. Since a quadratic linear prediction order is needed to express one pitch pulse, the linear prediction order (p) is expressed as the Equation 1.

The linear prediction analyzer 203 calculates a linear prediction coefficient by analyzing frequency domain highband signal based on the linear prediction order determined in the linear prediction order determiner 202. In short, an auto-correlation coefficient of the frequency domain highband signal is obtained and a linear prediction coefficient is obtained based on Levison Durbin algorithm.

The linear prediction coefficient quantizer 204 quantizes the linear prediction coefficient obtained in the linear prediction analyzer 203 based on lowband encoding information, i.e., the synthesized output signal of lowband encoder.

Meanwhile, the residual signal quantizer 205 dequantizes the linear prediction coefficient quantized in the linear prediction coefficient quantizer 204, and obtains a residual signal by performing linear prediction analysis filtering. The residual signal is called a linear prediction residual MDCT coefficient. The residual signal quantizer 205 quantizes the residual signal. In short, it divides the band of the residual MDCT coefficients into a several bands and quantizes the energy of each band and a coefficient of normalized residual MDCT coefficients. Herein, when the energy of each band is quantized, fixed codebook gain information of a lowband encoder can be used. In other words, quantization efficiency can be increased by quantizing the difference between the energy of each band and the fixed codebook gain of the lowband encoder, instead of quantizing energy information of each band.

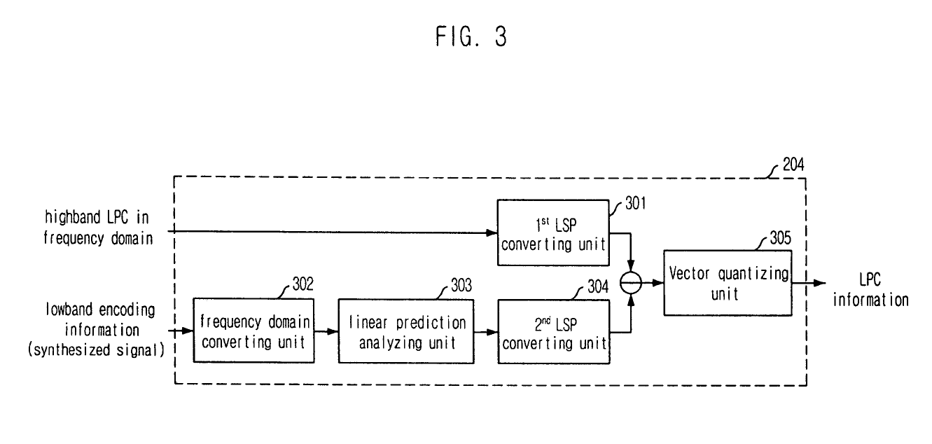

FIG. 3 is a diagram illustrating the linear prediction coefficient quantizer of FIG. 2. As illustrated in FIG. 3, the linear prediction coefficient quantizer 204 of FIG. 2 includes a first Line Spectrum Pair (LSP) converting unit 301, a frequency domain converting unit 302, a linear prediction analyzing unit 303, a second LSP converting unit 304, and a vector quantizing unit 305.

The first LSP converting unit 301 converts a highband linear prediction coefficient generated in the linear prediction analyzer 203 of FIG. 2 into an LSP.

The synthesized output signal of lowband encoder is transformed into frequency domain coefficients in frequency domain converting unit 302. For example, it converts the time domain synthesized signal of lowband encoder into a frequency domain through the MDCT.

The auto-correlation coefficient of the output signal of lowband encoder is transformed into the frequency domain, and then, the linear prediction coefficient is calculated based on the Levison Durbin algorithm in the linear prediction analyzing unit 303. The second line spectrum pair (LSP) converting unit 304 converts the linear prediction coefficient of the lowband synthesized signal into a line spectrum pair. The difference between a highband LSP obtained in the first LSP converting unit 301 and a lowband LSP obtained in the second LSP converting unit 304 are vector quantized in the vector quantizing unit 305.

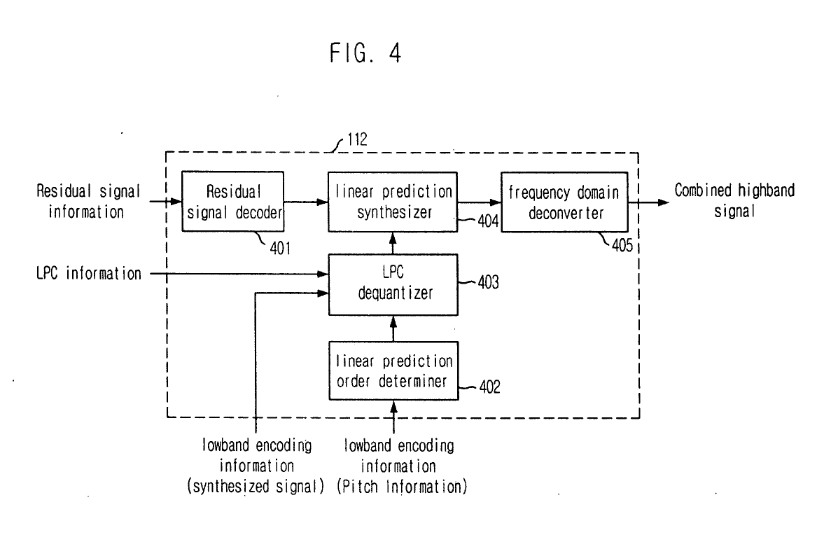

FIG. 4 is a block diagram showing a highband decoding apparatus in accordance with an embodiment of the present invention. As shown in FIG. 4, the highband decoding apparatus of the present invention includes a residual signal decoder 401, a linear prediction order determiner 402, a linear prediction coefficient dequantizer 403, a linear prediction synthesizer 404, and a frequency domain deconverter 405.

The residual signal decoder 401 makes a residual signal based on the coefficient of a normalized residual signal and the energy of each frequency band transmitted from the highband encoding apparatus. Herein, when the energy of each frequency band is not quantized and transmitted but a difference between the energy of each frequency band and a fixed codebook gain of the lowband encoding system is quantized and transmitted, the energy of each frequency band is made by quantizing the difference and adding the fixed codebook gain to the dequantized value.

The linear prediction order determiner 402 determines the linear prediction order by using lowband encoding information, which is pitch information, just as the encoding process. The linear prediction coefficient dequantizer 403 dequantizes linear prediction coefficient information transmitted from the highband encoding apparatus based on the determined linear prediction order and the lowband encoding information, which is a lowband synthesized signal, and thereby decodes the linear prediction coefficient.

The linear prediction synthesizer 404 performs linear prediction synthesis on the decoded residual signal based on the dequantized linear prediction coefficient. That is, it generates an MDCT coefficient by performing linear prediction synthesis filtering the decoded residual signal. The frequency domain deconverter 405 converts the linear prediction-synthesized signal into a highband signal of a time domain. That is, it outputs a highband signal of the time domain by performing inverse MDCT (IMDCT).

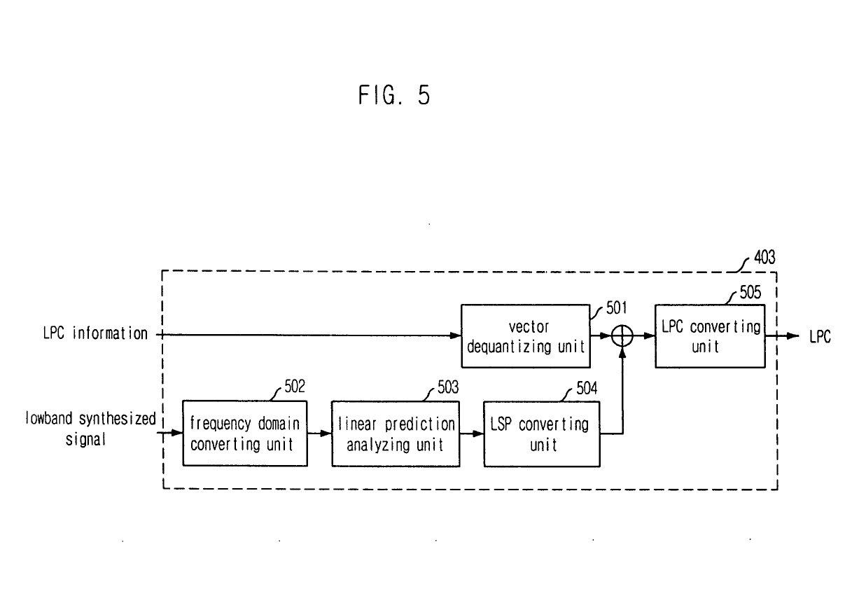

FIG. 5 is a block diagram illustrating a linear prediction coefficient dequantizer of FIG. 4. As shown in FIG. 5, the linear prediction coefficient dequantizer 403 includes a vector dequantizing unit 501, a frequency domain converting unit 502, a linear prediction analyzing unit 503, an LSP converting unit 504, and an LPC converting unit 505.

The vector dequantizing unit 501 makes a line spectrum pair by performing vector dequantization on the linear prediction coefficient information transmitted from the highband encoding apparatus. In short, it generates the difference between a highband LSP and a lowband LSP coefficients. The frequency domain converting unit 502 converts time domain synthesized output of lowband decoder into a frequency domain coefficients.

The linear prediction coefficients of the synthesized output signal of lowband encoder are calculated in the linear prediction analyzing unit 503. The LPC coefficients are calculated in frequency domain.

The LSP converting unit 504 converts the linear prediction coefficient of the output signal of lowband into a line spectrum pair. The output LSP of the vector dequantizing unit 501 and the LSP of transformed lowband synthesized signal of LSP converting unit 504 are added and converted into a linear prediction coefficient in the LPC converting unit 505. In short, a linear prediction coefficient of a highband signal is generated.

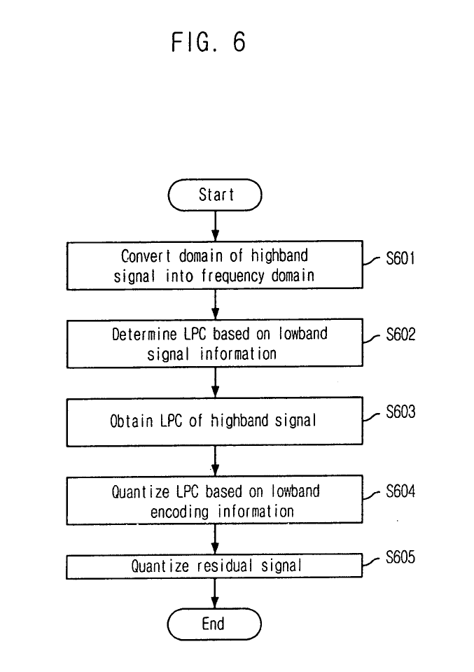

FIG. 6 is a flowchart describing a highband encoding method in accordance with an embodiment of the present invention. As shown in FIG. 6, at step S601, the domain of an input highband signal is converted into a frequency domain. For example, the domain of a highband signal is converted into a frequency domain through MDCT.

At step S602, a linear prediction order is determined based on lowband encoding information, e.g., pitch information of a lowband signal. Subsequently, at step S603, a linear prediction coefficient is obtained by analyzing the highband signal whose domain is converted into the frequency domain based on the determined linear prediction order. To put it in detail, after an auto-correlation coefficient of the highband signal whose domain is converted into the frequency domain is obtained, a linear prediction coefficient is calculated based on Levison Durbin algorithm.

At step S604, the linear prediction coefficient is quantized by using the lowband encoding information, e.g., lowband synthesis signal. At step S605, the quantized linear prediction coefficient is dequantized, and a residual signal is obtained by performing linear prediction analytic filtering based on the dequantized linear prediction coefficient. In short, the band of a residual signal is divided into several bands, and the energy of each band and the coefficient of a normalized residual signal are quantized. Herein, when the energy of each band is quantized, fixed codebook gain information of the lowband encoder can be utilized. The quantization efficiency can be increased by quantizing the difference between the energy of each band and the fixed codebook gain of the lowband encoder, instead of quantizing the energy information of each band.

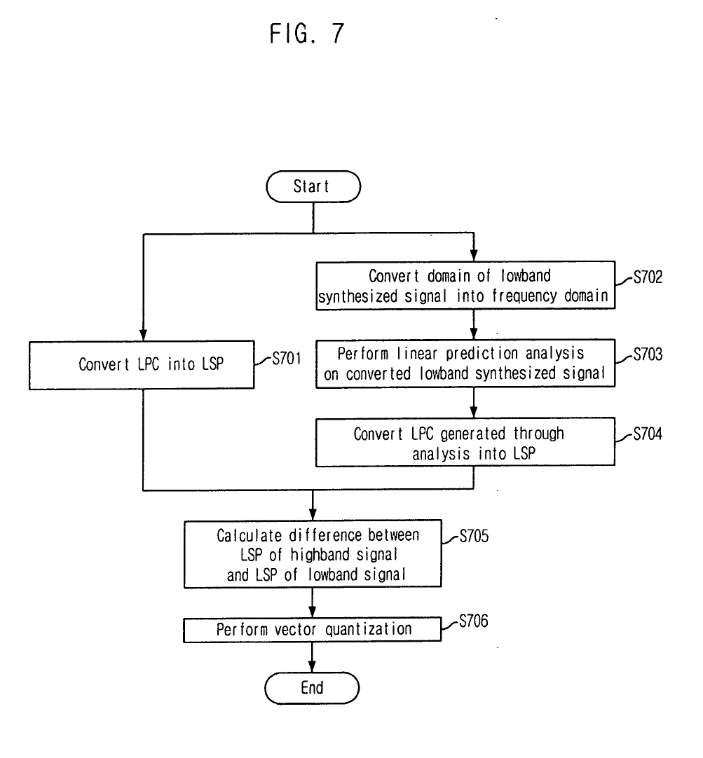

FIG. 7 is a flowchart illustrating a linear prediction coefficient quantizing process of the step S604. As illustrated in FIG. 7, at step S701, the linear prediction coefficient obtained at the step S603 of FIG. 6 is converted into a line spectrum pair.

Meanwhile, at step S702, the domain of a lowband synthesized signal is converted into a frequency domain. At step S703, linear prediction analysis is carried out on a lowband synthesis signal whose domain is converted into the frequency domain. To be specific, an auto-correlation coefficient of the lowband synthesized signal whose domain is converted into the frequency domain is obtained and then a linear prediction coefficient is calculated based on Levison Durbin algorithm. At step S704, the linear prediction coefficient is converted into a line spectrum pair.

At step S705, the difference between a line spectrum pair of a highband signal generated at the step S701 and a line spectrum pair of a lowband synthesized signal generated at the step S704 is calculated. At step S706, the difference is vector-quantized.

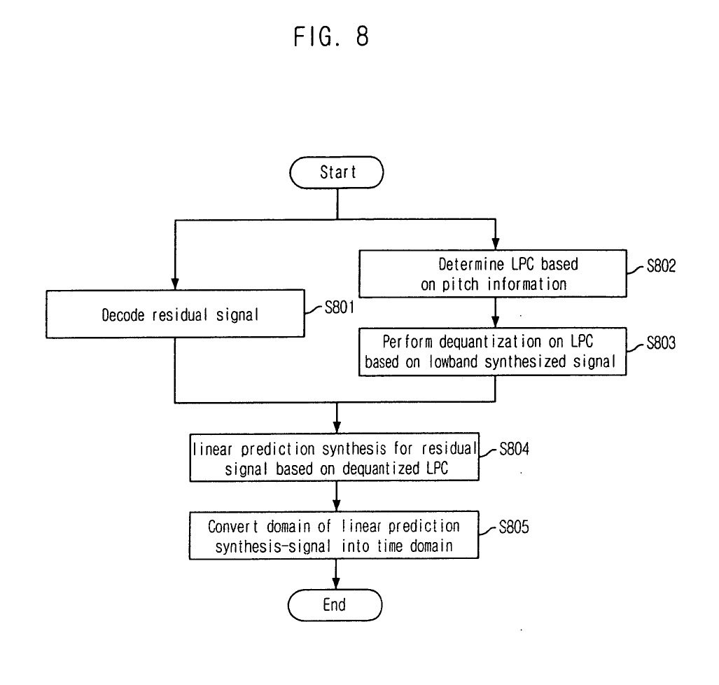

FIG. 8 is a flowchart showing a highband decoding method in accordance with an embodiment of the present invention. As illustrated in FIG. 8, at step S801, a residual signal is decoded based on a residual signal coefficient and the energy of each frequency band transmitted from the highband encoding apparatus. Herein, when the difference between the energy of each band and the fixed codebook gain of the lowband encoder is quantized and transmitted, instead of the energy of each frequency band, the energy of each frequency band can be restored by dequantizing the difference and adding the fixed codebook gain to the dequantized value.

At step S802, a linear prediction coefficient is determined based on lowband encoding information, e.g., pitch information, just as in the encoding process. At step S803, the linear prediction coefficient quantized and transmitted from the highband encoding apparatus is dequantized based on the lowband encoding information, e.g., a lowband synthesized signal.

At step S804, linear prediction synthesis is carried out on the residual signal decoded at the step S801 by using the dequantized linear prediction coefficient. That is, linear prediction synthesis filtering is performed on the decoded residual signal. At step S805, the linear prediction synthesized signal is converted into a highband signal of a time domain.

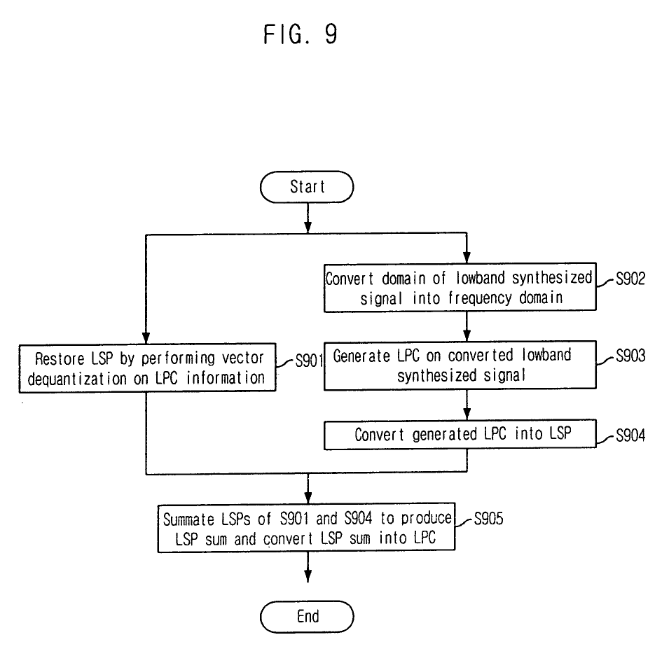

FIG. 9 is a flowchart illustrating a linear prediction coefficient dequantizing process of the step S803 in FIG. 8. As described in FIG. 9, at step S901, the line spectrum pair is maded by performing vector dequantization on the linear prediction coefficient which is quantized and transmitted in the highband encoding apparatus. That is, the difference between an LSP of a highband signal and an LSP of a lowband synthesized signal is restored.

At step S902, the domain of a lowband synthesized signal is converted into a frequency domain. At step S903, an auto-correlation coefficient of the lowband synthesized signal whose domain is converted into the frequency domain is obtained, and a linear prediction coefficient is calculated based on Levison Durbin algorithm.

Subsequently, at step S904, a linear prediction coefficient of the lowband synthesized signal is converted into a line spectrum pair. At step S905, the line spectrum pair restored at the step S901 is summated with a line spectrum pair obtained at the step S904, and the summated line spectrum pair is converted into a linear prediction coefficient.

The present invention described above has an effect that it can remove a pre-echo by calculating an optimal linear prediction order for Temporal Noise Shaping (TNS) based on lowband encoding information and applying the optimal linear prediction order to highband encoding. In other words, the removal of the pre-echo effectively removes noise generated not only in a shift section but also in a voiced sound to thereby produce high-quality signal. Also, the present invention has an effect that it can quantize the linear prediction coefficient used for highband encoding in a low transmission rate based on the lowband encoding information.

The present application contains subject matter related to Korean patent application No. 2004-0103158, filed in the Korean Intellectual Property Office on Dec. 8, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A highband encoding apparatus for encoding a highband signal based on lowband encoding information in a wideband encoding system, comprising:
a domain converting means for converting a domain of an input highband signal into a frequency domain;
a linear prediction order determining means for determining a linear prediction order based on the lowband encoding information;
a linear prediction analyzing means for analyzing a highband signal whose domain is converted into the frequency domain based on the determined linear prediction order to thereby generate a linear prediction coefficient;
a linear prediction coefficient quantizing means for quantizing the linear prediction coefficient based on the lowband encoding information; and
a residual signal quantizing means for obtaining a residual signal by dequantizing the quantized linear prediction coefficient and quantizing the residual signal.

2. The highband encoding apparatus as recited in claim 1, wherein the linear prediction coefficient quantizing means includes:
a first line spectrum pair (LSP) converting unit for converting the highband linear prediction coefficient into a highband line spectrum pair;
a lowband linear prediction analyzing unit for analyzing the lowband encoding information and generating a lowband linear prediction coefficient;
a second LSP converting unit for converting the lowband linear prediction coefficient into a lowband line spectrum pair; and
a vector quantizing unit for performing vector quantization on a difference between the highband line spectrum pair and the lowband line spectrum pair.

3. The highband encoding apparatus as recited in claim 1, wherein the linear prediction coefficient quantizing means uses a lowband synthesized signal as the lowband encoding information.

4. The highband encoding apparatus as recited in claim 1, wherein the linear prediction coefficient determining means uses pitch information of lowband signal as the lowband encoding information.

5. The highband encoding apparatus as recited in claim 1, wherein the residual signal quantizing means divides a band of a residual signal into a plurality of bands and quantizes energy of each band and a coefficient of a normalized residual signal.

6. A highband decoding apparatus for decoding a highband signal based on lowband encoding information in a wideband decoding system, comprising:
a residual signal decoding means for decoding a residual signal from a received bit stream;
a linear prediction order determining means for determining a linear prediction order based on the lowband encoding information;
a linear prediction coefficient dequantizing means for dequantizing a linear prediction coefficient from the received linear prediction coefficient information by using the determined linear prediction order and the lowband encoding information;
a linear prediction synthesizing means for performing linear prediction synthesis on the decoded residual signal by using the dequantized linear prediction coefficient; and
a domain converting means for converting a highband signal performed linear prediction synthesis into a highband signal of a time domain.

7. The highband decoding apparatus as recited in claim 6, wherein the linear prediction coefficient dequantizing means includes:
a vector dequantizing unit for restoring a first line spectrum pair by performing vector dequantization on linear prediction coefficient information inputted from outside;
a lowband linear prediction analyzing unit for analyzing the lowband encoding information and generating a lowband linear prediction coefficient;
an LSP converting unit for converting the lowband linear prediction coefficient into a second line spectrum pair; and
an LPC converting unit for summating the first line spectrum pair and the second line spectrum pair to thereby produce a summated line spectrum pair and converting the summated line spectrum pair into a linear prediction coefficient.

8. The highband decoding apparatus as recited in claim 6, wherein the linear prediction coefficient dequantizing means uses a lowband synthesized signal as the lowband encoding information.

9. The highband decoding apparatus as recited in claim 6, wherein the residual signal decoding means decodes a residual signal based on energy of each frequency band and a coefficient of a normalized residual signal.

10. The highband decoding apparatus as recited in claim 6, wherein the linear prediction coefficient determining means uses pitch information of a lowband signal as the lowband encoding information.

11. A highband encoding method for encoding a highband signal based on lowband encoding information in a wideband encoding system, comprising the steps of:
a) converting a domain of an input highband signal into a frequency domain;
b) determining a linear prediction order based on the lowband encoding information;
c) analyzing the highband signal whose domain is converted into the frequency domain based on the determined linear prediction order and generating a highband linear prediction coefficient;
d) quantizing the linear prediction coefficient based on the lowband encoding information; and
e) obtaining a residual signal by dequantizing the quantized linear prediction coefficient, and quantizing the obtained residual signal.

12. The highband encoding method as recited in claim 11, wherein the step d) includes the steps of:
d1) converting the highband linear prediction coefficient into a highband line spectrum pair;
d2) analyzing the lowband encoding information and generating a lowband linear prediction coefficient;
d3) converting the lowband linear prediction coefficient into a lowband line spectrum pair; and
d4) performing vector quantization on a difference between the highband line spectrum pair and the lowband line spectrum pair.

13. The highband encoding method as recited in claim 11, wherein a lowband synthesized signal is used as the lowband encoding information in the step d).

14. The highband encoding method as recited in claim 11, wherein pitch information of a lowband signal is used as the lowband encoding information in the step b).

15. The highband encoding method as recited in claim 11, wherein a band of a residual signal is divided into a plurality of bands, and energy of each band and a coefficient of a normalized residual signal are quantized in the step e).

16. A highband decoding method for decoding a highband signal based on lowband encoding information in a wideband decoding system, comprising the steps of:
a) decoding a residual signal from a received bit stream;
b) determining a linear prediction order based on the lowband encoding information;
c) dequantizing a linear prediction coefficient from the received linear prediction coefficient information based on the determined linear prediction order and the lowband encoding information;
d) performing linear prediction synthesis on the decoded residual signal based on the dequantized linear prediction coefficient; and
e) converting a highband signal performed linear prediction synthesis into a highband signal of a time domain.

17. The highband decoding method as recited in claim 16, wherein the step c) includes the steps of:
c1) restoring a first line spectrum pair by performing vector dequantization on linear prediction coefficient information inputted from outside;
c2) analyzing the lowband encoding information and generating a lowband linear prediction coefficient;
c3) converting a lowband linear prediction coefficient into a second line spectrum pair; and
c4) converting a summation of the first line spectrum pair and the second line spectrum pair into a linear prediction coefficient.

18. The highband decoding method as recited in claim 16, wherein a lowband synthesized signal is used as the lowband encoding information in the step c).

19. The highband decoding method as recited in claim 16, wherein a residual signal is made based on energy of each frequency band and a coefficient of a normalized residual signal in the step a).

20. The highband decoding method as recited in claim 16, wherein pitch information of a lowband signal is used as the lowband encoding information in the step b).
